(19) United States
(12) Patent Application Publication
(10) Pub. No.: US 2015/0332439 A1
(43) Pub. Date: Nov. 19, 2015

(54) METHODS AND DEVICES FOR HIDING PRIVACY INFORMATION

(71) Applicant: Xiaomi Inc., Beijing (CN)

(72) Inventors: Bo Zhang, Beijing (CN); Xinyu Liu, Beijing (CN); Zhijun Chen, Beijing (CN)

(73) Assignee: Xiaomi Inc.

(21) Appl. No.: 14/606,338

(22) Filed: Jan. 27, 2015

Related U.S. Application Data
(63) Continuation of application No. PCT/CN2014/089305, filed on Oct. 23, 2014.

(30) Foreign Application Priority Data
May 13, 2014 (CN) 201410200812.0

(51) Int. Cl. G06T 5/00; G06K 9/00

(52) U.S. Cl. CPC G06T 5/002; G06K 9/00442; G06T 2207/10004

(57) ABSTRACT

A method for a device to hide privacy information is provided. The method includes: recognizing a piece of privacy information in an image; identifying an information category corresponding to the piece of privacy information; and performing hiding processing to the piece of privacy information in the image based on the information category.

### CROSS-REFERENCE TO RELATED APPLICATIONS

This application is a continuation of International Application No. PCT/CN2014/089305, filed Oct. 23, 2014, which is based upon and claims priority to Chinese Patent Application No. 201410200812.0, filed May 13, 2014, the entire contents of all of which are incorporated herein by reference.

### TECHNICAL FIELD

The present disclosure relates to the field of image processing and, more particularly, to methods and devices for hiding privacy information.

### BACKGROUND

Photo-sharing applications are widely used on mobile terminals such as smartphones, tablet computers, e-book readers and hand-held devices. Pictures shared by these applications often carry privacy information, such as license plate numbers, mobile phone numbers, instant messaging account names, human faces, etc. Conventional methods for hiding privacy information in a picture often includes recognizing character information in the picture by an Optical Character Recognition (OCR) technology, performing blurring processing to the region which contains character information, and using the picture in which the character information has been blurred in the photo-sharing application.

### SUMMARY

According to a first aspect of the present disclosure, there is provided a method for a device to hide privacy information, comprising: recognizing a piece of privacy information in an image; identifying an information category corresponding to the piece of privacy information; and performing hiding processing to the piece of privacy information in the image based on the information category.

According to a second aspect of the present disclosure, there is provided a device for hiding privacy information, comprising: a processor; and a memory for storing instructions executable by the processor. The processor is configured to: recognize a piece of privacy information in an image; identify an information category corresponding to the piece of privacy information; and perform hiding processing to the piece of privacy information in the image based on the information category.

According to a third aspect of the present disclosure, there is provided a non-transitory computer-readable storage medium having stored therein instructions that, when executed by a processor of a terminal device, cause the terminal device to perform operations including: recognizing a piece of privacy information in an image; identifying an information category corresponding to the piece of privacy information; and performing hiding processing to the piece of privacy information in the image based on the information category.

It is to be understood that both the foregoing general description and the following detailed description are exemplary rather than limiting the present disclosure.

### BRIEF DESCRIPTION OF THE DRAWINGS

The accompanying drawings, which are hereby incorporated in and constitute a part of this specification, illustrate embodiments consistent with the invention and serve to explain the principles of the invention.

FIG. 1 is a flowchart of a method for hiding privacy information, according to an exemplary embodiment.

FIG. 2A is a flowchart of a method for hiding privacy information, according to another exemplary embodiment.

FIG. 2B is a schematic diagram illustrating a method for recognizing text information, according to an exemplary embodiment.

FIG. 2C is a schematic diagram illustrating a method for recognizing privacy information, according to an exemplary embodiment.

FIG. 3 is a schematic diagram illustrating an example for hiding privacy information, according to an exemplary embodiment.

FIG. 4 is a block diagram of a device for hiding privacy information, according to an exemplary embodiment.

FIG. 5 is a block diagram of a device for hiding privacy information, according to another exemplary embodiment.

FIG. 6 is a block diagram of a terminal device, according to an exemplary embodiment.

### DETAILED DESCRIPTION

Reference will now be made in detail to exemplary embodiments, examples of which are illustrated in the accompanying drawings. When accompanying drawings are mentioned in the following description, the same numbers in different drawings represent the same or similar elements, unless otherwise represented. The following exemplary embodiments and description thereof intend to illustrate, rather than to limit, the present disclosure. Hereinafter, the present disclosure will be described with reference to the drawings.

The terminal devices described in the present disclosure include, e.g., cellphones, tablet computers, e-book readers, Moving Picture Experts Group Audio Layer III (MP3) players, Moving Picture Experts Group Audio Layer IV (MP4) players, portable laptop computers, desktop computers and so on.

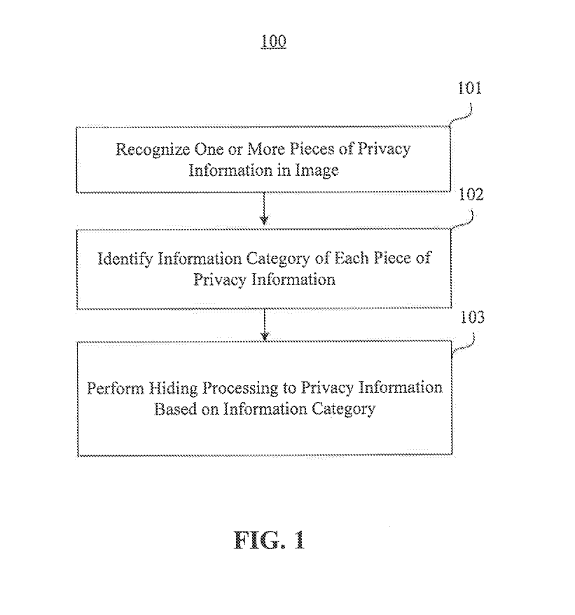

FIG. 1 is a flowchart of a method 100 for hiding privacy information according to an exemplary embodiment. The method 100 may be performed by a terminal device. Referring to FIG. 1, the method 100 includes the following steps.

In step 101, the terminal device recognizes one or more pieces of privacy information in an image, such as a picture. The privacy information includes, for example, text information and/or face information.

In step 102, the terminal device identifies an information category for each piece of privacy information in the image. The information category of text information includes, for example, telephone numbers, bank account numbers, license plate numbers, cellphone numbers, account names, sensitive keywords, addresses, web addresses, postcodes, genders, names, nicknames, or any other category. The information category of face information includes, for example, a current user's face, a friend's face, a celebrity's face, or any other face.

In step 103, the terminal device performs a hiding processing to the privacy information in the image based on the information category. By performing hiding processing to the privacy information in the image based on the information category, different processing techniques may be applied to hide the privacy information based on the information category of the privacy information.

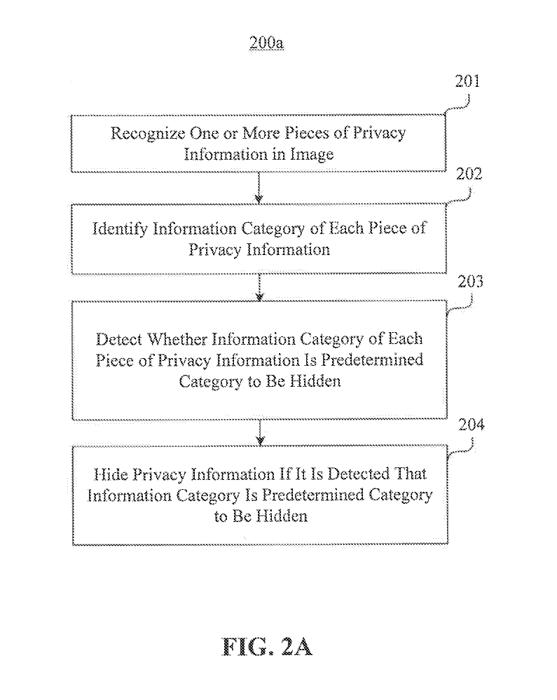

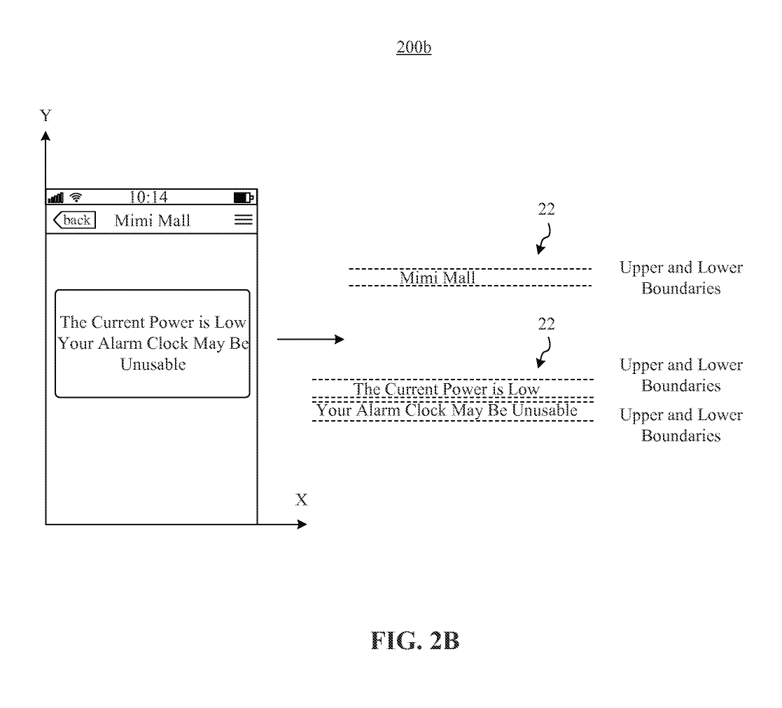

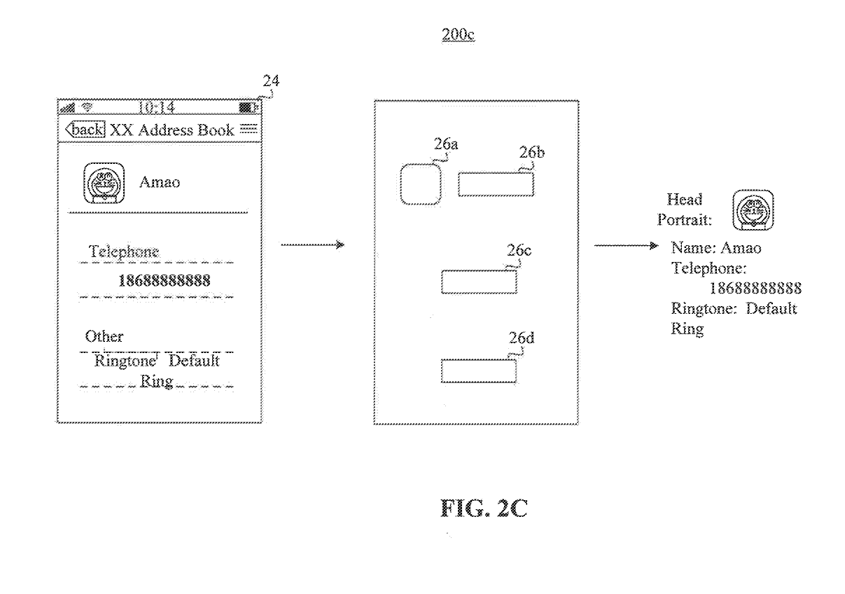

FIG. 2A is a flowchart of a method 200a for hiding privacy information, according to another exemplary embodiment. The method 200a may be performed by a terminal device. Referring to FIG. 2A, the method 200a includes the following steps.

In step 201, the terminal device recognizes one or more pieces of privacy information in an image, such as a picture.

For example, the terminal device may detect that there is a picture to be shared and recognize at least one piece of privacy information in the picture at the time of sharing the picture. The privacy information in the picture includes, for example, text information and/or face information.

In some embodiments, the terminal device may recognize the text information in the picture by performing the following substeps.

In a first substep, the terminal device performs pre-processing of the picture. For example, the terminal device may convert the picture to be shared to a grayscale picture, and then filter the grayscale picture. Filtering the grayscale picture can remove noise in the grayscale picture.

In a second substep, the terminal device performs binarization processing to the grayscale picture to obtain a binary picture. The terminal device may also remove the noise in the binary picture after performing binarization processing to the grayscale picture.

In a third substep, the terminal device locates and extracts one or more text candidate regions from the binary picture. For example, if the picture shared by the terminal device is a screen capture, texts in the picture are usually positioned in a relatively straight direction. FIG. 2B is a schematic diagram illustrating a method 200b for recognizing text information, according to an exemplary embodiment. As shown in FIG. 2B, the terminal device projects a binary picture to the Y-axis in the coordinate system established based on pixels of the picture. The terminal device identifies text candidate regions 22 to contain text information, and determines upper and lower boundaries of each of the text candidate regions 22 according to the projection result, as shown in FIG. 2B.

In a fourth substep, the terminal device performs character segmentation based on the extracted text candidate regions. For example, the terminal device may perform character segmentation to a text candidate region based on a width of a character, to obtain individual character blocks after segmentation.

In a fifth substep, the terminal device performs character recognition based on the character blocks. For example, the terminal device may perform character recognition to the segmented character blocks by using a preset character library.

In a sixth substep, the terminal device outputs a recognition result of the text information.

In some embodiments, the terminal device may recognize human faces from the picture by using a face recognition algorithm.

In some embodiments, if the image is a screen capture, the terminal device may acquire application program information or display interface information corresponding to the screen capture, identify one or more image regions based on the application program information or the display interface information, each of which contains a piece of privacy information, and recognize the corresponding privacy information based on the image region. In other words, because configurations of the display interfaces in application programs are generally unvarying, the terminal device may pre-store a plurality of templates corresponding to the respective application programs and their display interfaces. For example, a template records the region information of one or more regions where effective information corresponding to an application program and its display interface is located. The region information may be used to locate and recognize the privacy information.

FIG. 2C is a schematic diagram illustrating a method 200c for recognizing privacy information, according to an exemplary embodiment. As shown in FIG. 2C, the image is a screen capture 24. The terminal device acquires the display interface information corresponding to the screen capture 24, e.g., “the contacts interface of xx address book.” Then, the terminal device checks the template corresponding to the display interface information, i.e., “the contacts interface of xx address book.” In the illustrated embodiment, the template records regions 26a-26d where effective information in the contacts interface is located and an information category of each of the regions 26a-26d. The terminal device then extracts and recognizes the corresponding privacy information from the screen capture 24 based on the regions 26a-26d.

Referring back to FIG. 2A, in step 202, the terminal device identifies an information category of each piece of privacy information in the image. The information category of text information includes, for example, telephone numbers, bank account numbers, license plate numbers, cellphone numbers, account names, sensitive keywords, addresses, web addresses, postcodes, genders, names, nicknames, and unknown categories. The information category of face information includes, for example, a current user's face, a friend's face, a celebrity's face, or any other face.

In exemplary embodiments, if the recognized privacy information is text information, the terminal device may identify the information category of the privacy information based on a preset rule, such as a rule based on regular expressions. Different rules may be set corresponding to different information categories.

For example, the terminal device may identify the information category of 0510-4405222 or 021-87888822 being a telephone number based on a regular expression, e.g., \d{3}-\d{8}|\d{4}-\d{7}, corresponding to the telephone number.

As another example, the terminal device may identify the information category being a numeric account name with a value more than 10000 based on a regular expression, e.g., [1-9][0-9]{4,}.

As another example, the terminal device may identify the information category being an E-mail address based on a regular expression, e.g., \w+([-+.]\w+)*@\w+([-.]\w+)*\.\w+([-.]\w+)*<mailto:*@\w+([-.]\w+)*\.\w+([-.]\w+)*>, corresponding to the E-mail address.

As another example, the terminal device may identify the information category being a web link based on a regular expression, e.g., [a-zA-z]+://[̂\s]*, corresponding to the web link.

In some embodiments, if the privacy information is text information, the terminal device may identify the information category of the text information based on semantic analysis of text context. For example, a preceding piece of text information is a text message “do you have a new card, please give me the number” and a current piece of text information is a text message “hi, buddy, my new number is 18688888888, please keep.” Then the terminal device may determine through semantic analysis that “hi, buddy, my new number is, please keep” belongs to an unknown category, while “18688888888” is a telephone number.

In some embodiments, if the image is a screen capture, the terminal device may acquire application program information or display interface information corresponding to the screen capture, and identify the information category of each piece of privacy information. Because configurations of the application programs and of the display interfaces in application programs are generally unvarying, the terminal device may pre-store templates corresponding to the respective application programs and display interfaces. For example, a template records the region information of one or more regions where effective information corresponding to an application program and its display interface is located. The region information may be used to locate and recognize the privacy information.

Referring to FIG. 2C, the image is the screen capture 24. In the illustrated embodiment, the information category of the image information obtained from the first region 26a is “head portrait” according to the region information corresponding to the first region 26a, the information category of the word information obtained from the second region 26b is “name” according to the region information corresponding to the second region 26b, the information category of the digital information obtained from the third region 26c is “telephone” according to the region information corresponding to the third region 26c, and the information category of the word information obtained from the fourth region 26d is “ringtone” according to the region information corresponding to fourth region 26d.

If the privacy information is human face information, the terminal device may identify the information category of face information based on a preset face information database. The preset face information database may include a current user's face information, a friend's face information, and/or a celebrity's face information. The terminal device may determine, by face matching, whether the recognized face information is the current user's face, the friend's face, the celebrity's face, or any other face.

Referring back to FIG. 2A, in step 203, the terminal device detects whether the information category of each piece of privacy information is a predetermined category to be hidden.

In some embodiments, the terminal device may store a first mapping relationship between each information category and whether the information category is a predetermined category to be hidden. The terminal device may detect whether the information category of each piece of privacy information is a predetermined category to be hidden by checking the first mapping relationship. For example, the first mapping relationship may the following:

| Information category | Required to be hidden or not |
|---|---|
| telephone number | yes |
| bank account number | yes |
| nickname | no |
| celebrity's face | no |
| current user's face | no |
| . . . | . . . |

The first mapping relationship may be pre-stored by the terminal device or generated by user input. Moreover, during usage of the terminal device, the terminal device may receive an input signal triggered by the user to modify the first mapping relationship. The first mapping relationship may be modified according to the input signal. For example, the state of whether the information category of “current user's face” is a predetermined category to be hidden in the first mapping relationship may be modified from “no” to “yes”.

In step 204, the terminal device hides the privacy information if it is detected that the corresponding information category is a predetermined category to be hidden.

In some embodiments, the terminal device may determine a hiding range and/or a means of hiding the privacy information based on the information category. For example, the terminal device may store a second mapping relationship between each information category and a hiding range and/or hiding means. The hiding range includes, for example, hiding the entire privacy information or hiding a part of the privacy information. The hiding means includes, for example, adding mosaic, adding color block covering, and/or blurring processing. The hiding means may further include the same hiding means with different parameters, such as slight mosaic, moderate mosaic and heavy mosaic. The terminal device may determine the hiding range and/or hiding means corresponding to the information category by checking the second mapping relationship. An example second mapping relationship is shown as follows:

| Information category | Hiding range | Hiding means |
|---|---|---|
| telephone number | last 8 digits | adding color block covering |
| | | with the background color |
| bank account number | all digits | blurring processing |
| license plate number | all digits | blurring processing |
| address | all words | adding heavy mosaic |
| unknown face | all face regions | adding slight mosaic |
| . . . | . . . | . . . |

The second mapping relationship may be pre-stored by the terminal device or generated by user input. Moreover, during usage of the terminal device, the terminal device may receive an input signal from the user to modify the second mapping relationship. The second mapping relationship may be modified according to the input signal.

The terminal device may hide the privacy information based on the determined hiding range and/or hiding means. If it is detected that the information category is not a predetermined category to be hidden, the terminal device may not process the corresponding privacy information. The terminal device may then share the image in which the privacy information has been processed and hidden.

By recognizing at least one piece of privacy information in the image, identifying an information category of each piece of privacy information, and performing hiding processing to the privacy information in the image based on the information category, the method 200a allows privacy information to be processed differently based on the information category of the privacy information.

The method 200a also allows the user to perform personalized information hiding by selecting different ranges and means of hidings for privacy information based on the information category.

When the image is a screen capture, by acquiring the application program information or display interface information corresponding to the screen capture, extracting and recognizing the privacy information through the application program information or display interface information, and identifying the information category of privacy information, the method 200a improves the accuracy of the identified information category of the privacy information.

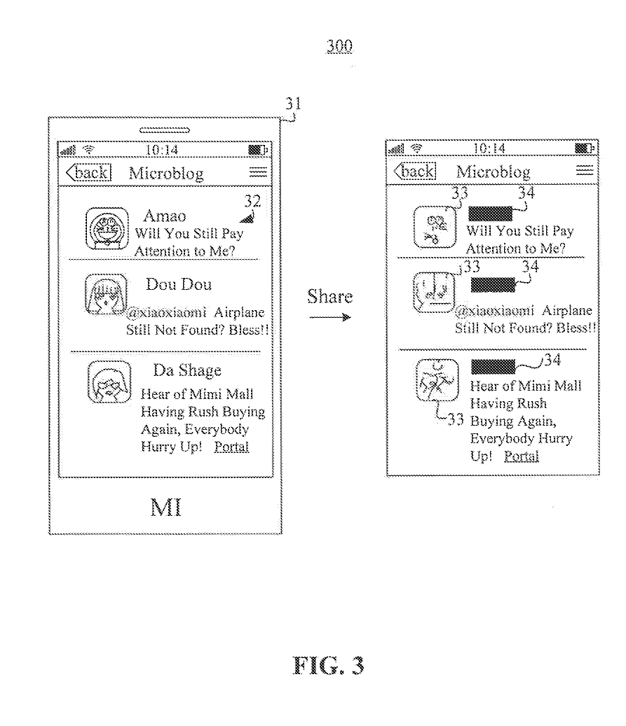

FIG. 3 is a schematic diagram illustrating an example 300 for hiding privacy information, according to an exemplary embodiment. As shown in FIG. 3, the user captures a screen capture 32 to share when using a micro blog application installed on a cellphone 31. The cellphone 31 detects privacy information in the screen capture 32 and analyzes the privacy information in the screen capture 32. Then, blurring processing is made to head portraits 33 and nicknames 34 in the privacy information while other contents in the screen capture 32 remain as they are. Afterwards, the cellphone 31 shares the processed image in which blurring processing has been performed.

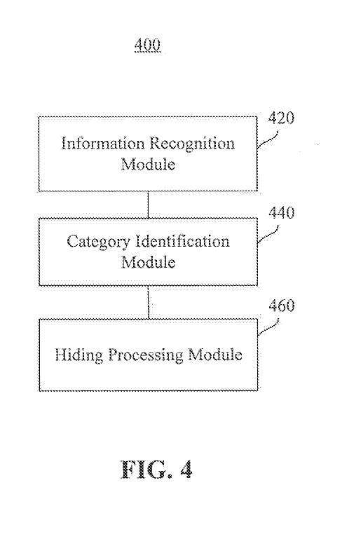

FIG. 4 is a block diagram of a device 400 for hiding privacy information, according to an exemplary embodiment. The device 400 may be implemented to be all or a part of a terminal device by software, hardware, or a combination thereof. The device 400 includes an information recognition module 420, a category identification module 440, and a hiding processing module 460.

The information recognition module 420 is configured to recognize one or more pieces of privacy information in an image. The category identification module 440 is configured to identify an information category of each piece of privacy information in the image. The hiding processing module 460 is configured to perform hiding processing to the privacy information in the image based on the information category. The device 400 allows privacy information to be processed differently based on the information category of the privacy information.

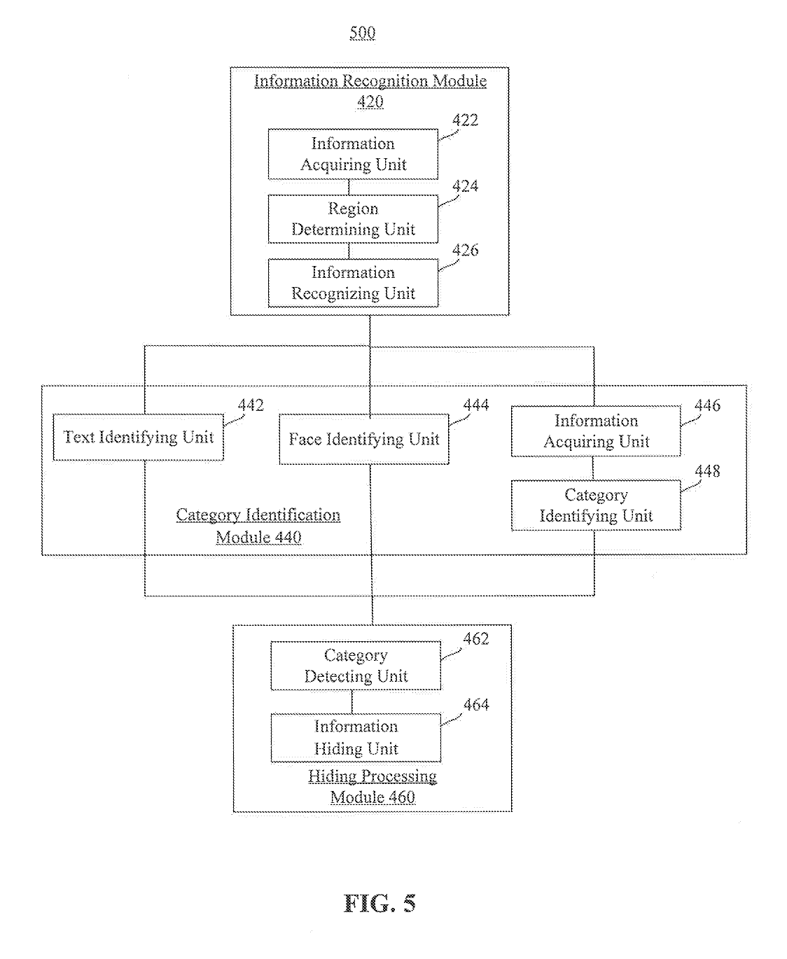

FIG. 5 is a block diagram of a device 500 for hiding privacy information, according to another exemplary embodiment. The device 500 may be implemented to be all or a part of a terminal device by software, hardware, or a combination thereof. The device 500 includes an information recognition module 420, a category identification module 440, and a hiding processing module 460.

The information recognition module 420 is configured to recognize one or more pieces of privacy information in an image. The category identification module 440 is configured to identify an information category of each piece of privacy information in the image. The hiding processing module 460 is configured to perform hiding processing to the privacy information in the image based on the information category.

In exemplary embodiments, the category identification module 440 includes a text identifying unit 442 and/or a face identifying unit 444.

The text identifying unit 442 is configured to identify the information category of the privacy information based on a preset rule when the privacy information is text information. Different rules may be applied to different information categories. In some embodiments, the text identifying unit 442 may identify the information category of the text information based on semantic analysis of text context.

The face identifying unit 444 is configured to identify the information category of face information based on a preset face information database when the privacy information is human face information.

In exemplary embodiments, the category identification module 440 further includes an information acquiring unit 446 and a category identifying unit 448.

The information acquiring unit 446 is configured to acquire application program information or display interface information corresponding to a screen capture when the image is the screen capture.

The category identifying unit 448 is configured to identify the information category of each piece of privacy information in the image based on the application program information or the display interface information.

In exemplary embodiments, the hiding processing module 460 includes a category detecting unit 462 and an information hiding unit 464.

The category detecting unit 462 is configured to detect whether the information category of each piece of privacy information is a predetermined category to be hidden.

The information hiding unit 464 is configured to hide the privacy information when the category detecting unit 462 detects that the corresponding information category is a predetermined category to be hidden.

The information hiding unit 464 may include a hiding determining subunit and an information hiding subunit (not shown). The hiding determining subunit may be configured to determine a hiding range and/or a hiding means of the privacy information based on the information category. The information hiding subunit may be configured to hide the privacy information based on the hiding range and/or the hiding means.

In exemplary embodiments, the information recognition module 420 includes an information acquiring unit 422, a region determining unit 424, and an information recognizing unit 426.

The information acquiring unit 422 is configured to acquire the application program information or the display interface information corresponding to a screen capture when the image is a screen capture.

The region determining unit 424 is configured to identify one or more image regions in the image based on the application program information or the display interface information, each of which contains a piece of privacy information.

The information recognizing unit 426 is configured to recognize the corresponding privacy information based on the image region.

The device 500 may allow the user to perform personalized information hiding by selecting different ranges and means of hidings to the privacy information based on the information category.

When the image is a screen capture, by acquiring the application program information or display interface information corresponding to the screen capture, extracting and recognizing the privacy information through the application program information or display interface information, and identifying the information category of the privacy information, the device 500 improves the accuracy of the identified information category of the privacy information.

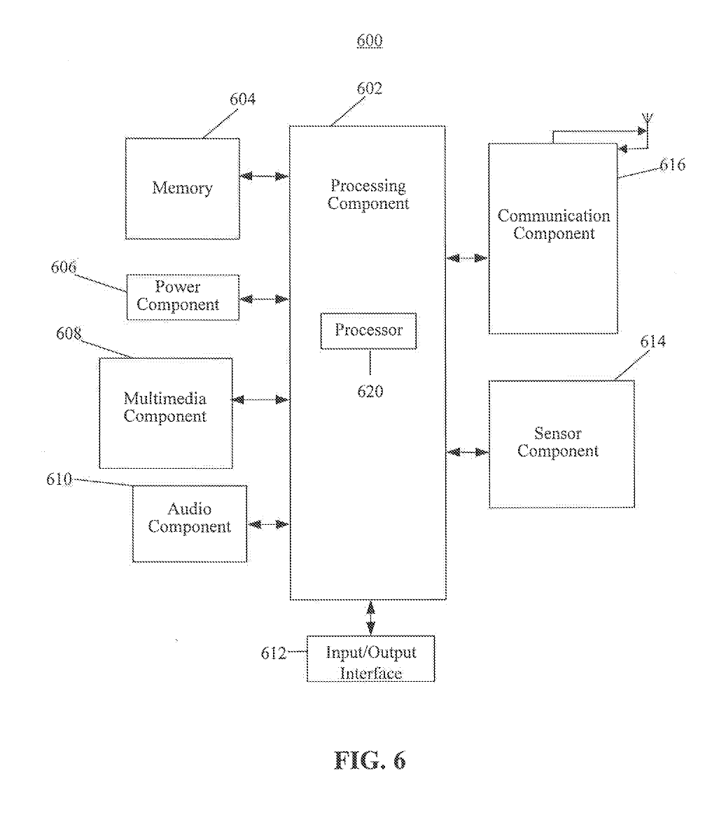

FIG. 6 is a block diagram of a terminal device 600, according to an exemplary embodiment. For example, the terminal device 600 may be a mobile phone, a computer, a digital broadcast terminal, a messaging device, a gaming console, a tablet, a medical device, exercise equipment, a personal digital assistant, and/or the like. The terminal device 600 may include one or more of the following components: a processing component 602, a memory 604, a power component 606, a multimedia component 608, an audio component 610, an input/output (I/O) interface 612, a sensor component 614, and a communication component 616. The person skilled in the art should appreciate that the structure of the terminal device 600 as shown in FIG. 6 does not intend to limit the terminal device 600. The terminal device 600 may include more or less components or combine some components or other different components.

The processing component 602 typically controls overall operations of the terminal device 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the terminal device 600. Examples of such data include instructions for any applications or methods operated on the terminal device 600, contact data, phonebook data, messages, pictures, videos, etc. The memory 604 is also configured to store programs and modules. The processing component 602 performs various functions and data processing by operating programs and modules stored in the memory 604. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 is configured to provide power to various components of the terminal device 600. The power component 606 may include a power management system, one or more power sources, and/or any other components associated with the generation, management, and distribution of power in the terminal device 600.

The multimedia component 608 includes a screen providing an output interface between the terminal device 600 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, slides, and gestures performed on the touch panel. The touch sensors may not only sense a boundary of a touch or slide action, but also sense a period of time and a pressure associated with the touch or slide action. In some embodiments, the multimedia component 608 includes a front camera and/or a rear camera. The front camera and/or the rear camera may receive an external multimedia datum while the terminal device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 may include a microphone configured to receive an external audio signal when the terminal device 600 is in an operation mode, such as a call mode, a recording mode, and/or a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and/or a locking button.

The sensor component 614 includes one or more sensors to provide status assessments of various aspects of the terminal device 600. For instance, the sensor component 614 may detect an on/off status of the terminal device 600, relative positioning of components, e.g., the display and the keypad, of the terminal device 600, a change in position of the terminal device 600 or a component of the terminal device 600, a presence or absence of user contact with the terminal device 600, an orientation or an acceleration/deceleration of the terminal device 600, and/or a change in temperature of the terminal device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the terminal device 600 and other devices. The terminal device 600 can access a wireless network based on a communication standard, such as WiFi, 2G, or 3G, or a combination thereof. In one exemplary embodiment, the communication component 616 receives a broadcast signal or information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and/or other technologies.

In exemplary embodiments, the terminal device 600 may be implemented with one or more application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components, for performing the above described methods.

In exemplary embodiments, there is also provided a non-transitory computer-readable storage medium including instructions, such as included in the memory 604, executable by the processor 620 in the terminal device 600 for performing the above-described methods. For example, the non-transitory computer-readable storage medium may be a ROM, a random access memory (RAM), a CD-ROM, a magnetic tape, a floppy disc, an optical data storage device, and the like.

It should be understood by those skilled in the art that the above described methods, devices, and modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. The present disclosure is meant to cover any variations, usage or adaptive change of these embodiments, and these variations, usage or adaptive change follow general concept of the present disclosure and include the common knowledge or the customary technical means in the technical field that is not disclosed in the present disclosure.

It should be understood that the present disclosure is not limited to the exact structures that are described above and shown in the accompanying drawings, and may be modified and changed without departing from the scope of the present disclosure. It is intended that the scope of the invention only be limited by the appended claims.

What is claimed is:

1. A method for a device to hide privacy information, comprising:
recognizing a piece of privacy information in an image;
identifying an information category corresponding to the piece of privacy information; and
performing hiding processing to the piece of privacy information in the image based on the information category.

2. The method according to claim 1, wherein the information category is identified based on a preset rule if the piece of privacy information is text information.

3. The method according to claim 1, wherein the information category is identified based on a preset face information database if the piece of privacy information is face information.

4. The method according to claim 1, further comprising:
if the image is a screen capture, acquiring at least one of application program information or display interface information corresponding to the screen capture; and
identifying the information category corresponding to the piece of privacy information in the image based on the at least one of application program information or display interface information.

5. The method according to claim 1, further comprising:
detecting whether the information category is a predetermined category to be hidden; and
hiding the piece of privacy information if it is detected that the information category is a predetermined category to be hidden.

6. The method according to claim 5, further comprising:
determining at least one of a hiding range or a hiding means corresponding to the piece of privacy information based on the information category; and
hiding the piece of privacy information based on the at least one of the hiding range or the hiding means.

7. The method according to claim 1, further comprising:
if the image is a screen capture, acquiring at least one of application program information or display interface information corresponding to the screen capture;
identifying an image region which contains the piece of privacy information based on the at least one of application program information or display interface information; and
recognizing the piece of privacy information based on the image region.

8. A device for hiding privacy information, comprising:
a processor; and
a memory for storing instructions executable by the processor;
wherein the processor is configured to:
recognize a piece of privacy information in an image;
identify an information category corresponding to the piece of privacy information; and
perform hiding processing to the piece of privacy information in the image based on the information category.

9. The device according to claim 8, wherein the processor is further configured to:
identify the information category based on a preset rule if the piece of privacy information is text information.

10. The device according to claim 8, wherein the processor is further configured to:
identify the information category based on a preset face information database if the piece of privacy information is face information.

11. The device according to claim 8, wherein the processor is further configured to:
if the image is a screen capture, acquire at least one of application program information or display interface information corresponding to the screen capture; and
identify the information category based on the at least one of application program information or display interface information.

12. The device according to claim 8, wherein the processor is further configured to:
detect whether the information category is a predetermined category to be hidden; and
hide the privacy information if it is detected that the information category is a predetermined category to be hidden.

13. The device according to claim 12, wherein the processor is further configured to:
determine at least one of a hiding range or a hiding means corresponding to the piece of privacy information based on the information category; and
hide the piece of privacy information based on the at least one of the hiding range or the hiding means.

14. The device according to claim 8, wherein the processor is further configured to:
if the image is a screen capture, acquire at least one of application program information or display interface information corresponding to the screen capture;
identify an image region which contains the piece of privacy information based on the at least one of application program information or display interface information; and
recognize the piece of privacy information based on the image region.

15. A non-transitory computer-readable medium having stored therein instructions that, when executed by a processor of a terminal device, cause the terminal device to perform operations including:
recognizing a piece of privacy information in an image;
identifying an information category corresponding to the piece of privacy information; and
performing hiding processing to the piece of privacy information in the image based on the information category.
